(19) United States
(12) Patent Application Publication
(10) Pub. No.: US 2026/0228871 A1
(43) Pub. Date: Aug. 6, 2026

(54) SYSTEM AND METHOD FOR IMAGE ERROR DETECTION ON A WEBSITE

(71) Applicant: Noibu Technologies Inc., Ottawa (CA)

(72) Inventors: Kirill KUTS, Ottawa (CA); Oleksii BABIK, Ottawa (CA); David SEEL, Ottawa (CA); Patrick KIDNEY, Ottawa (CA); Joshua KOOPFERSTOCK, Ottawa (CA); Charlie GRACIE, Ottawa (CA)

(21) Appl. No.: 19/046,813

(22) Filed: Feb. 6, 2025

(51) Int. Cl. G06T 7/00; G06F 9/451; G06T 11/00

(52) U.S. Cl. CPC G06T 7/0002; G06F 9/451; G06T 11/10; G06T 2200/24; G06T 2207/10016

(57) ABSTRACT

Described are various embodiments of system and method for image error detection on a website. In one embodiment, the method comprises monitoring, by a script running on a browser of a first user device, a user session on a website for a HTML image element error, and validating a presence of the image error stemming from the HTML image element error. In some embodiments, the error is validated by sending through the browser a first HEAD request to a URL associated with the HTML image element error; and upon no image content type being returned, sending, by the script, a second HEAD request to the URL through a reverse proxy. An image of a video replay at the time the error is identified is modified by adding one or more static highlight elements identifying a location of the error.

### FIELD OF THE DISCLOSURE

The present disclosure relates to website error evaluation, and, in particular, to a system and method for image error detection on a website.

### BACKGROUND

One of the most recurrent problems with e-commerce websites or platforms is the presence of missing or broken image links. Such occurrences can be hard to detect, and invariably lead to a poor customer experience. For example, missing images on Product Listing Pages (PLPs) and Product Detail Pages (PDPs) can block conversions. E-commerce website managers may miss key insight about their products without image error detection, for example: “Did the blue shoes not sell because nobody likes blue? Or because the blue product image was broken?”. Existing solutions for identifying these types of errors typically runs a piece of code in the customer's browser to track any errors returned, for example when an image attempts to load and fails. While this technology does capture image errors, it typically has a high degree of false positives.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a system and method that advantageously allows to automatically detect and report missing or broken images on e-commerce websites.

In accordance with a first aspect, there is provided a computer-implemented method of detecting an image error on a website, comprising the steps of monitoring, by a script running on a browser of a first user device, a user session on a website for a HTML image element error; validating, by the script, a presence of the image error stemming from the HTML image element error; storing, on one or more servers, image error data associated with the image error; and generating, on the one or more servers, one or more static highlight elements indicative of a location of said image error on the website.

In some embodiments, validating comprises the steps of: sending, by the script, through the browser, a first HEAD request to a URL associated with the HTML image element error; checking, by the script, whether an image content type is returned; and upon no image content type being returned, sending, by the script, a second HEAD request to the URL through a reverse proxy.

In some embodiments, image error is validated upon the second HEAD request returning a response code equal to or higher than 400.

In some embodiments, monitoring comprises acquiring video image data of the user session, and wherein the image error data comprises a video replay of the session comprising video Document Object Model (DOM) data.

In some embodiments, generating the broken image highlight element comprises the steps of: searching, by the server, the video DOM data for an occurrence of a HTML image element associated with the HTML image element error at a time the HTML image element error occurred; upon identifying said occurrence, modifying an image of said video replay at said time to add thereto the one or more static highlight elements.

In some embodiments, the one or more static highlight elements comprise a colored border element.

In some embodiments, the method further comprises the step of: presenting on a graphical user interface (GUI) of a second user device said image with one or more instructions.

In some embodiments, the instructions comprise an image URL associated with said broken image.

In accordance with a second aspect, there is provided a system for detecting an image error on a website, comprising: one or more servers; a first user device communicatively coupled to the one or more servers, the first user device comprising a user script executed in a browser thereof configured to: monitor a user session on a website for a HTML image element error; and validate a presence of the image error stemming from the HTML image element error; and wherein said one or more servers are further configured to: store image error data associated with the image error; generate one or more static highlight elements indicative of a location of said image error on the website.

In some embodiments, the one or more servers comprise at least one reverse proxy server, and wherein said one or more servers are configured to validate by: sending, by the script one first user device a first HEAD request to a URL associated with the HTML image element error; checking, by the script, whether an image content type is returned; and upon no image content type being returned, sending, by the script, a second HEAD request to the URL through the reverse proxy server.

In some embodiments, the image error is validated upon the second HEAD request returning a response code equal to or higher than 400.

In some embodiments, monitoring comprises acquiring video image data of the user session, and wherein the image error data comprises a video replay of the session comprising video Document Object Model (DOM) data.

In some embodiments, generating the broken image highlight element comprises the steps of: searching, by the server, the video DOM data for an occurrence of a HTML image element associated with the HTML image element error at a time the HTML image element error occurred; upon identifying said occurrence, modifying an image of said video replay at said time to add thereto the one or more static highlight elements.

In some embodiments, the one or more static highlight elements comprise a colored border element.

In some embodiments, the one or more servers are further configured to present on a graphical user interface (GUI) of the second user device said image with one or more instructions.

In some embodiments, the instructions comprise an image URL associated with said broken image.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1 is a schematic diagram illustrating a system for detecting an image error on a website, in accordance with one embodiment;

FIG. 2 is a box diagram illustrating a user device and a server of the system of FIG. 1, in accordance with one embodiment;

FIG. 3 is a flow diagram illustrating an image error detection method, in accordance with one embodiment;

FIG. 4 is a flow diagram illustrating an image error validation step of the method of FIG. 3, in accordance with one embodiment;

FIG. 5 is a flow diagram of a broken image highlight creation step of the method of FIG. 3, in accordance with one embodiment; and

FIG. 6 is a photograph of a user interface showing a picture of a webpage comprising a validated broken image error, in accordance with one embodiment.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

The present disclosure provides examples, in accordance with different embodiments, of an image error detection method and system that helps e-commerce managers and developers to identify broken image files rapidly and efficiently on e-commerce websites, so that they can be resolved before causing significant business impact. The method disclosed herein provides a means of identifying image errors (or other types of errors) while reducing the false positive rate to nearly zero, by performing a number of additional verifications in a novel way. It further includes a novel image error previewer that allows e-commerce managers to quickly verify the validity of the detected error.

The system comprises, in accordance with different embodiments, a script or computer-executable code portion that will allow image error detection to be performed and validated. In some embodiments, the system and method rely on monitoring and capturing a plurality of user events (e.g., clicks, keyboard events, scrolls, etc.) on a user device to identify one or more pre-conditions (e.g., designated user events, alone or in sequence). Video data from each user session may also be captured for later review. While the following disclosure is mainly directed to e-commerce applications, the skilled person in the art will appreciate that other types of applications may also benefit from the disclosure.

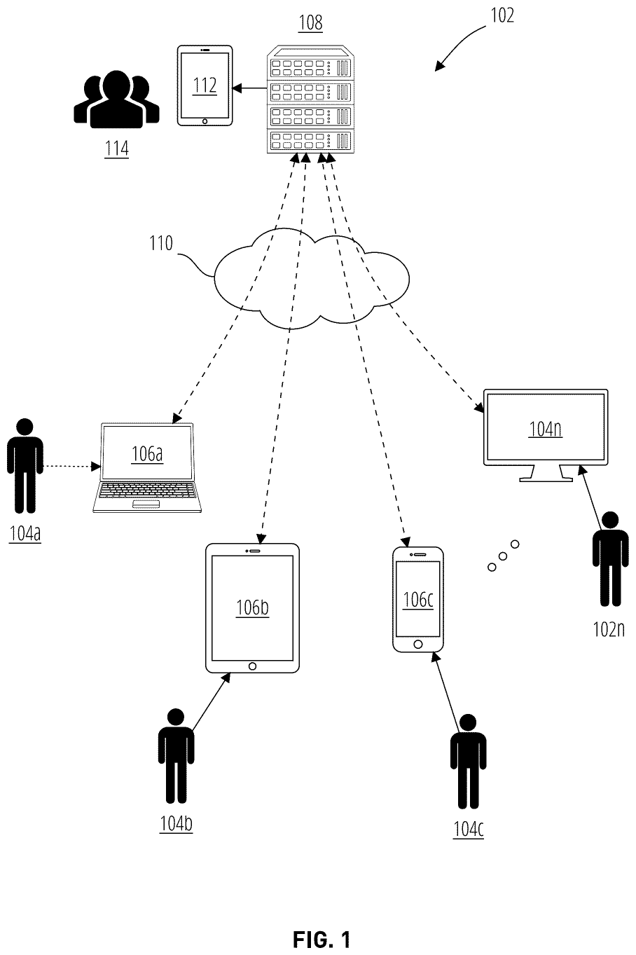

FIG. 1 shows a schematic diagram illustrating an exemplary broken image monitoring system 102, in accordance with one embodiment. In this example, the system 102 is implemented as a cloud-based software-as-a-service (SaaS) platform or the like. A plurality of users 104a . . . 104n may each use or interact with a corresponding user device 106a, . . . 106n to access a dedicated user session of an online e-commerce application or platform hosted by the server 108 (or one or more other servers coupled to server 108) via the network 110.

In some embodiments, the user-devices 106a-106n may take the form of any computing or digital processing device, including for example, but not limited to, a desktop computer, a laptop computer, a tablet, a smartphone, a smartwatch or the like. Although a single server 108 is illustrated in FIG. 1, the skilled person in the art will appreciate that the server 108 may comprise a plurality of communicatively coupled servers or the like. In some other embodiments, the system 102 may comprise partial or full offline functionality, and thus not require, or require in a limited fashion, the server 108. More generally, the functionality discussed herein may also be implemented on one or more computing devices or systems. The system 102 further configures the server 108 to provide outputs to a device 112 accessible by one or more administrative users 114 regarding application errors experienced by the users 104a . . . 104n. The system 102 further allows the administrative users 114 to review or receive notifications indicative of a validated broken image error. Administrative users 114 are therefore notified immediately when problems, errors or anomalies are detected.

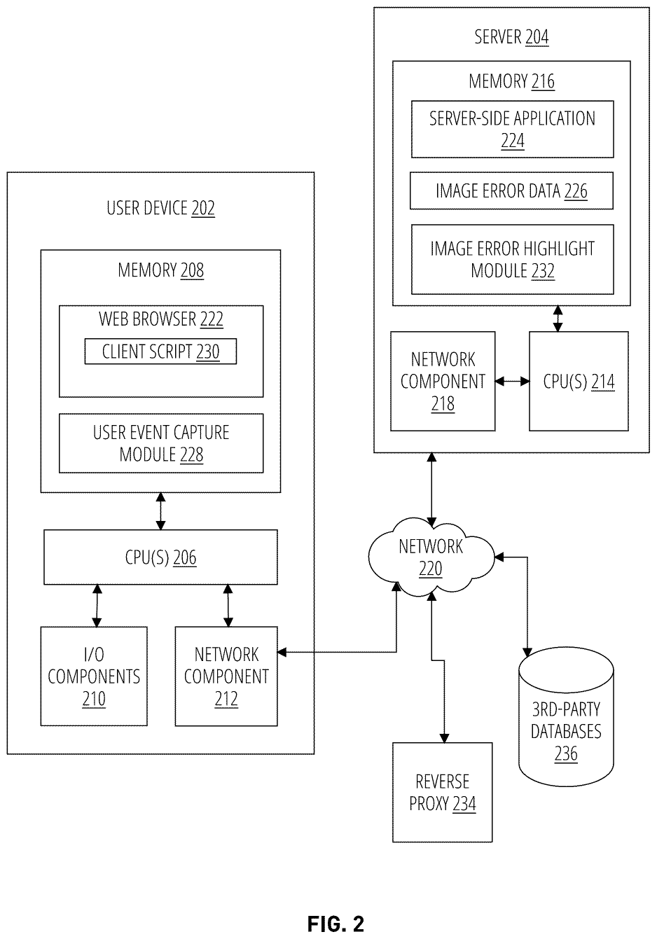

FIG. 2 is a block diagram illustrating an exemplary user device 202 and server 204, both of which are computing or digital processing devices (corresponding for example to any user device 106a-106n and server 108 of FIG. 1, respectively). The user device 202 thus comprises one or more digital processors (e.g., CPU(s) 206), a memory 208, I/O components 210, and a network component 212. The server 204 similarly comprises one or more processors (e.g., CPU(s) 214), a memory 216 and a network component 218. In this example, the server 204 may be configured to provide the e-commerce functionality in parallel with the error monitoring and analysis functionality. However other implementations may have the server 204 be a dedicated error monitoring server coupled to one or more servers providing the e-commerce functionality separately.

In some embodiments, the memories 208 and 216 may comprise any known form of computer memory or storage. This may include, for example, but without limitation, storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory, solid state memory or other memory technology, CDROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any method, application or module herein described may be implemented using computer readable/executable instructions that may be stored or otherwise held by such computer readable media and executed by the one or more processors.

In some embodiments, the CPU(s) 206 and 214 may include any known type of digital processor or the like. This can include general purpose processors (e.g., x86 or the like), embedded processors, or programmable processors (e.g., field programmable gate array processors or FPGA). Further, unless the context clearly indicates otherwise, any processor set out herein may be implemented as a singular processor or as a plurality of processors. The plurality of processors may be arrayed or distributed, and any processing function referred to herein may be carried out by one or by a plurality of processors, even though a single processor may be exemplified.

The network component 212 and 218 each may be configured to enable the computing device to communicate and/or exchange data with other components, to access and connect to network resources, to serve applications, and/or perform other computing applications by connecting to a network 220. The network 220 can be a single network or multiple connected networks capable of carrying data, including the Internet, an Ethernet network, integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples, or any combination thereof.

The input/output components (e.g., I/O components 210) of the user device 202 allow communication with a human user via an associated input, output, or input/output device such as a keyboard, a mouse, a touchscreen, and display. The display may be used to generate a graphical user interface (GUI) or the like. In the case where an administrator uses the user device, the GUI is used to provide information about the application errors encountered and their analysis.

As mentioned above, in some embodiments, the system may be configured using a client-server model or the like. The user device 202 may comprise a web browser 222 in memory 208 which, upon being executed by the CPU(s) 206 allow the user device 202 to communicate with the server 204 via the network component 212. The server 204 may comprise in the memory 216 a server-side application 224 that allows the CPU(s) 214 to respond to or communicate with the user device 202 via the network component 218. In addition, the server may use the captured image error data 226 (including recorded videos of user sessions or the like) retrieved, in some embodiments, from the user device 202.

In some embodiments, user session information may be captured from recorded user sessions (e.g., screen recordings), for example via a data collector or user event capture module 228 stored in memory 208 of the user device 202. In some embodiments, the image error detection application is implemented in combination with the user device (e.g., client script 230), and backend applications running on server 204 (e.g., image error highlight module 232).

In some embodiments, the image error detection method of the present disclosure relies on using at least one reverse proxy 234 or the like. Typically, reverse proxies are servers that are located between the one or more web browsers running on user devices, and the one or more web servers. These can intercept and inspect client requests before forwarding them to the web server, and subsequently returning the server's response to the client.

In some embodiments, different modules/instructions may be combined or distributed on different devices, in accordance with different implementations. In some embodiments, user-event information and associated application information may be captured from recorded user sessions. For example, in some embodiments, the user-event information may be captured on the client side. For example, the session information may be collected from users accessing the e-commerce application. The client script 230 and/or data collector module or user event capture module 228 may be provided as a script that is downloaded and run as part of the e-commerce application and/or embedded in a webpage of the e-commerce application. The script may be an initial script downloaded and run in order to capture any potential errors resulting when loading the e-commerce application. The browser information may provide information about the browser version, plug-ins, etc. as well as information about the operating system of the user's device.

In some embodiments, the server 204 and/or user device 202 may further be configured to communicate with one or more 3rd-party databases 236 via network 220. This may include, for example, one or more 3rd-party servers or databases relating to different services, for example email servers, scheduling systems, or the like.

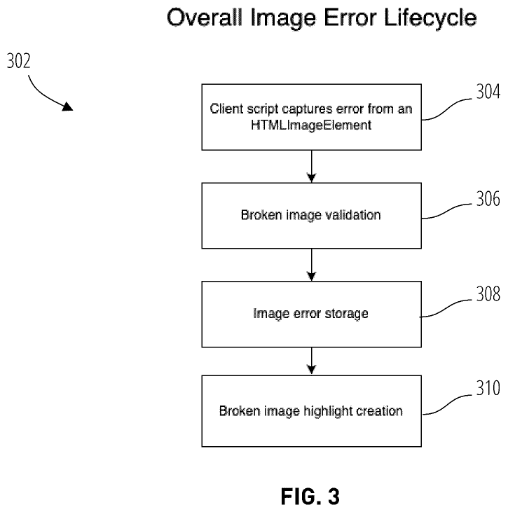

FIG. 3 provides an overview of the image error detection lifecycle 302, in accordance with one embodiment. At step 304, the client script or computer-executable code portion running on a web browser 222 of the user device 202 (such as a e-commerce website) monitors the presence of errors issued from HTML image elements. At step 306, the detected broken image is validated to confirm whether it represents a true broken image event or not. At step 308, if the error was confirmed and validated in step 306, the image error data is stored. In some embodiments, this image error data is stored in the session and saved to the backend. In some embodiments, the image error data comprises a video replay which is also stored with every session as well, containing the Document Object Model (DOM) and its mutations at all points in time. Finally, at step 310, a broken image highlight element is generated. This may be used to provide a visual representation of the image error and associate data to a site manager or the like.

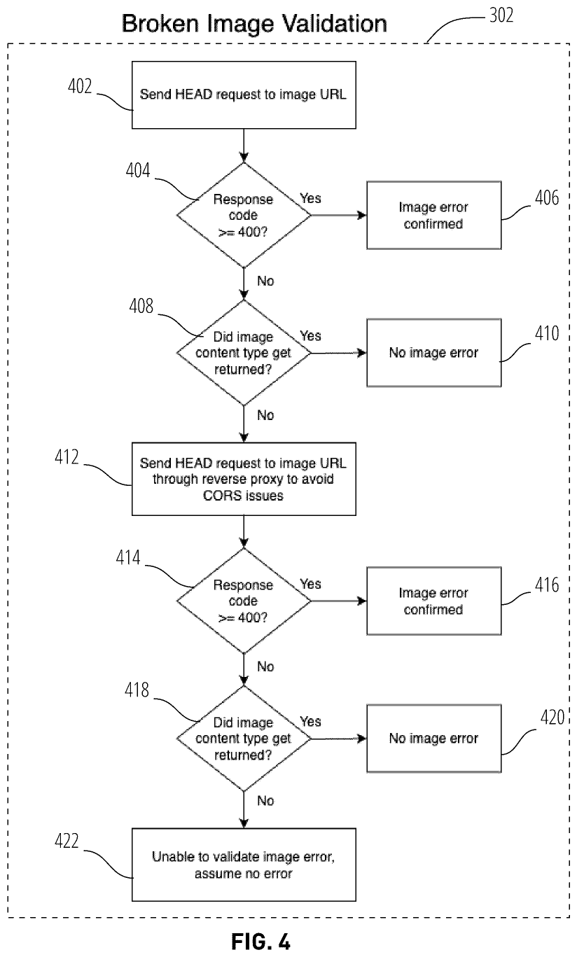

FIG. 4 is a flow diagram illustrating an exemplary implementation of the broken image validation step 302, in accordance with one embodiment. First, at step 402, a HEAD request is sent to the URL of the image directly from the script running in the browser. At step 404, if the HEAD request returns a response code of 400 or higher, the image error is confirmed at step 406. If not, the content type is checked at step 408, and if the content type returned is of type image, and the request succeeded, the error is ignored as a false positive at step 410. However, often the HEAD request will not succeed due to CORS (Cross Origin Resource Sharing) policies. To test if this is the case, at step 412, the same HEAD request is sent again but through a reverse proxy rather than directly from the browser. This will bypass any CORS issues.

The HEAD request is checked again at step 414 for a response code. If the HEAD request returns a response code of 400 or higher, the image error is confirmed at step 416. If not, the script checks if the content type returned is of type image at step 418, and if the request succeeded, the error is ignored as a false positive at step 420. Finally, if no image content type was returned, the image error cannot be validated, and by default the method assumes that no error is present at step 422.

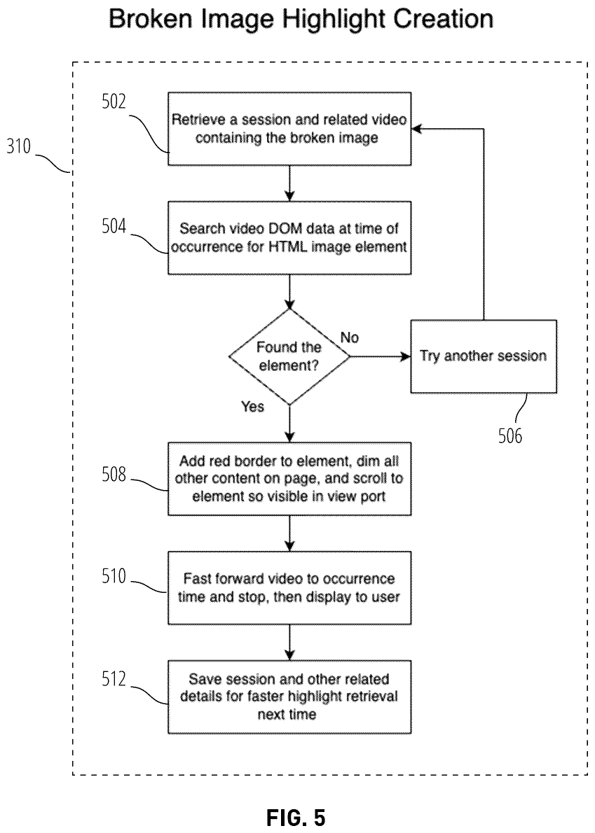

FIG. 5 is a flowchart illustrating an exemplary implementation of the broken image highlight creation step 310 mentioned above, in accordance with one embodiment. In this example, at step 502, a session and related video is retrieved that contains the validated broken image. At step 504, the video DOM data is searched for an occurrence of the HTML image element associated with the error at the time it occurred. If the element is not found in the video, at step 506, additional sessions are retrieved and searched until the element is found (go back to step 502). Once the element is found, at step 508 the video is modified to add a visual border to the element, dim all other content on the page, and scroll to the element so it is visible in an user interface display or viewport. In some embodiments the visual border may be colored in red, or another color. At step 510, the video is fast forwarded to the point in time and stopped, displayed to the user as a static highlight of the broken image on the website. Finally, at step 512, in some embodiments, the session and other related details are saved to the backend for faster subsequent highlight retrievals.

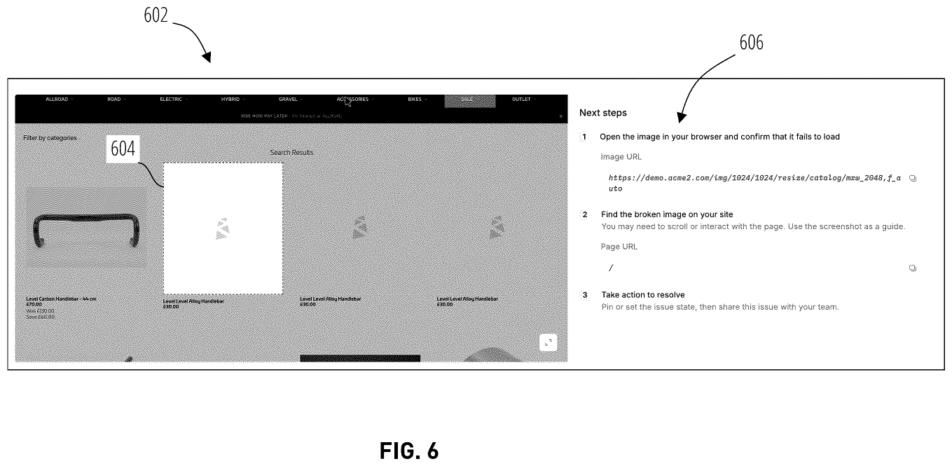

In some embodiments, as illustrated in FIG. 6, a graphical user interface (GUI) or online console/portal, can be provided to a site administrator or the like for them to preview the validated error. In the exemplary embodiment of FIG. 6, a page 602 is displayed showing a picture of the webpage with the error and the generated error highlight element 604. Moreover, the UI can provide a list of instructions 606 comprising, for example the URL of the page where the validated broken image was found.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

What is claimed is:

1. A computer-implemented method of detecting an image error on a website, comprising the steps of:
monitoring, by a script running on a browser of a first user device, a user session on a website for a HTML image element error;
validating, by the script, a presence of the image error stemming from the HTML image element error;
storing, on one or more servers, image error data associated with the image error; and
generating, on the one or more servers, one or more static highlight elements indicative of a location of said image error on the website.

2. The computer-implemented method of claim 1, wherein said validating comprises the steps of:
sending, by the script, through the browser, a first HEAD request to a URL associated with the HTML image element error;
checking, by the script, whether an image content type is returned; and
upon no image content type being returned, sending, by the script, a second HEAD request to the URL through a reverse proxy.

3. The computer-implemented method of claim 2, wherein the image error is validated upon the second HEAD request returning a response code equal to or higher than 400.

4. The computer-implemented method of claim 1, wherein said monitoring comprises acquiring video image data of the user session, and wherein the image error data comprises a video replay of the session comprising video Document Object Model (DOM) data.

5. The computer-implemented method of claim 4, wherein said generating the broken image highlight element comprises the steps of:
searching, by the server, the video DOM data for an occurrence of a HTML image element associated with the HTML image element error at a time the HTML image element error occurred;
upon identifying said occurrence, modifying an image of said video replay at said time to add thereto the one or more static highlight elements.

6. The computer-implemented method of claim 5, wherein the one or more static highlight elements comprise a colored border element.

7. The computer-implemented method of claim 5, further comprising the step of:
presenting on a graphical user interface (GUI) of a second user device said image with one or more instructions.

8. The computer-implemented method of claim 7, wherein said instructions comprise an image URL associated with said broken image.

9. A system for detecting an image error on a website, comprising:
one or more servers;
a first user device communicatively coupled to the one or more servers, the first user device comprising a user script executed in a browser thereof configured to:
monitor a user session on a website for a HTML image element error; and
validate a presence of the image error stemming from the HTML image element error; and
wherein said one or more servers are further configured to:
store image error data associated with the image error;
generate one or more static highlight elements indicative of a location of said image error on the website.

10. The system of claim 9, wherein said one or more servers comprise at least one reverse proxy server, and wherein said one or more servers are configured to validate by:
sending, by the script one first user device a first HEAD request to a URL associated with the HTML image element error;
checking, by the script, whether an image content type is returned; and
upon no image content type being returned, sending, by the script, a second HEAD request to the URL through the reverse proxy server.

11. The system of claim 9, wherein the image error is validated upon the second HEAD request returning a response code equal to or higher than 400.

12. The system of claim 9, wherein said monitoring comprises acquiring video image data of the user session, and wherein the image error data comprises a video replay of the session comprising video Document Object Model (DOM) data.

13. The system of claim 12, wherein said generating the broken image highlight element comprises the steps of:
searching, by the server, the video DOM data for an occurrence of a HTML image element associated with the HTML image element error at a time the HTML image element error occurred;
upon identifying said occurrence, modifying an image of said video replay at said time to add thereto the one or more static highlight elements.

14. The system of claim 13, wherein the one or more static highlight elements comprise a colored border element.

15. The system of claim 9, further comprising a second user device, and wherein the one or more servers are further configured to present on a graphical user interface (GUI) of the second user device said image with one or more instructions.

16. The system of claim 15, wherein said instructions comprise an image URL associated with said broken image.
